(19) United States
(12) Patent Application Publication
(10) Pub. No.: US 2008/0223549 A1
(43) Pub. Date: Sep. 18, 2008

(54) Air-Conditioning Device, in Particular for a Motor Vehicle

(75) Inventor: Claude Schlachter, Wolschwille (FR)

Correspondence Address: FOLEY AND LARDNER LLP;SUITE 500, 3000 K STREET NW, WASHINGTON, DC, 20007, US

(73) Assignee: BEHR FRANCE S.A.R.L.

(21) Appl. No.: 10/591,466

(22) PCT Filed: Mar. 3, 2005
(86) PCT No.: PCT/EP2005/002235

§ 371 Date: Apr. 17, 2008

(30) Foreign Application Priority Data
Mar. 3, 2004 (EP) 04290598.4

(51) Int. Cl. B60H 1/00; F25B 29/00

(52) U.S. Cl. 165/65; 454/159

(57) ABSTRACT

The invention relates to an air-conditioning device (10) which is used to air-condition an area, in particular the passenger compartment of a motor vehicle, comprising a heat exchanger which can be cross-flown by air, which is to be air-conditioned, and which is arranged inside an air guiding channel (12), wherein a cross-flowable heating device (18) is arranged downstream therefrom. According to the invention, the air guiding channel (12) extends in a deviation free manner and in an essentially linear direction between the heat exchanger (16) and the heating device (18).

The present invention relates to an air conditioning device for climate control of a space, in particular of a vehicle interior space, having the features of the preamble of patent claim 1.

In known vehicle air conditioning systems, there is often the problem that the air supply ducts between the fan, the heat exchanger and the heating device have a plurality of deflections, which can lead to relatively severe throttling of the airflow and to pronounced noise generation. Further parameters which can prevent or hinder a favorable air profile are the installation conditions in the vehicle. It is often not possible to obtain the desired rectilinear air paths on account of the space available.

In known air conditioning systems, cold and warm air is guided into a mixing space, from where the air is conducted to the outflow openings in the direction of the vehicle interior space. From a temperature mixing space which is situated lower down, the air flows upward to the defrosting and ventilation nozzles. The air must be conducted downward again in the direction of the footwell. Said deflections are unfavorable because of the pressure drop they cause and with regard to acoustics. This relates in particular to the long deflection paths to the outflow openings in the footwell.

The present invention is based on the object of providing an air conditioning system for maintaining the temperature in, or providing climate control of, the interior space, which air conditioning system is optimized with regard to its flow conditions and acoustics.

Said object is achieved by the subject matter of the independent patent claim. Features of advantageous refinements of the invention can be gathered from the dependent claims.

In an air conditioning device according to the invention as per patent claim 1, an air guiding duct runs largely rectilinearly and without deflection between a heat exchanger and a heating device. In this way, the air path in the air conditioning system can be kept very short and direct, so that both a pressure drop and the generation of noise as a result of excessively severe deflections of the air path can be avoided. In the air conditioning system according to the invention, the heating body is situated directly downstream of the evaporator, so that no deflections are necessary between them. The heating body is closed or opened by means of a flap, a closable sliding device or the like. If said heating body is supplied with electrical current, it heats the air. Said flap can be a rolling tape or a moveable flap or can be formed from a plurality of relatively small flaps which are coupled to one another by means of a kinematic arrangement.

A variably closable bypass duct for feeding cold air can also be provided in the air guiding duct parallel to the heating device, the air guiding duct likewise running largely rectilinearly and without deflection between the heat exchanger and the bypass duct. Flow losses and noise generation as a result of relatively severe deflection of the air guiding duct are avoided in this way. A closure device, which can be variably adjusted between a closed position and an opened position, is preferably arranged within the bypass duct. A further closure device, which can be variably adjusted between a closed position and an opened position, for metering warm air can be arranged upstream or downstream of the heating device. It is possible for said further closure device in the warm air duct to be formed from a plurality of pivoting flaps which are coupled together or, for example, to be formed from one or more flaps which can be moved and/or partially rolled up.

The pivoting flaps in the bypass duct need not be as compact as the closure device for the heating body, since more space is available here.

A significant aspect of the invention is the heating body arranged directly downstream of the evaporator, said heating body having very compact closure devices. There are no significant deflections in the air guidance between the heating body and the evaporator. In addition, a V-shaped conducting device for the cold air is situated in the bypass duct. This divides the cold air into two flows which can selectively be conducted upward or downward. The space between the two cold air paths is utilized for the distribution of the warm air flow which flows from the heating body. The two warm air outlets in the footwell and in the region of the windows are therefore arranged centrally, while the cold air paths run laterally. In order to maintain the temperature of the air, the central V-shaped region is embodied as a stratification duct which is actuated by means of a flap. Said stratification duct guides the cold air into the central region of the system where it can be deflected in the desired direction.

The invention is explained in more detail in the following in terms of preferred exemplary embodiments on the basis of the associated drawings, in which:

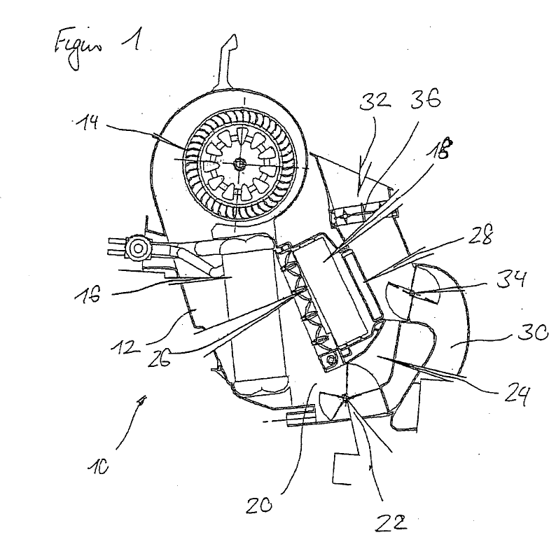

FIG. 1 is a schematic sectioned illustration of an air conditioning device according to the invention,

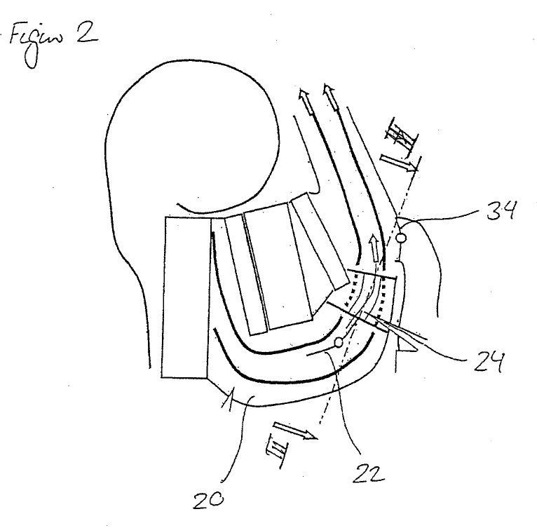

FIGS. 2 to 7 are various schematic illustrations for displaying the possible air guiding paths in the air conditioning device,

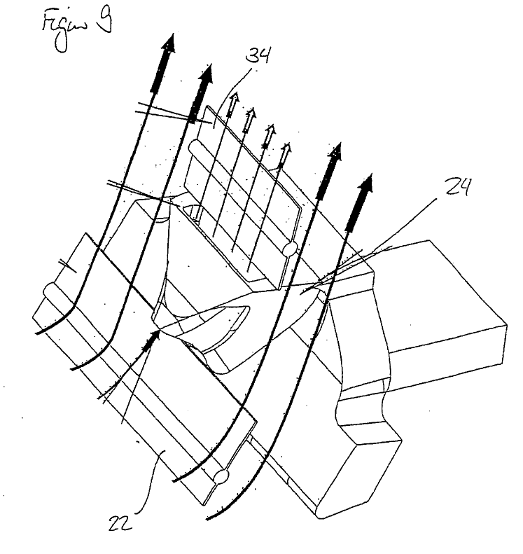

FIG. 8 is a perspective diagrammatic illustration of the air guiding paths in a first operating mode of the device and

FIG. 9 is a perspective diagrammatic illustration of the air guiding paths in a second operating mode of the device.

FIG. 1, in a schematic diagrammatic illustration, displays the arrangement of the components of an air conditioning device 10 according to the invention. An evaporator 16 is arranged in an air guiding duct 12 downstream of a fan 14, a heating body 18 being arranged downstream of said evaporator 16. The heating body 18 is situated directly downstream of the evaporator 16, so that the air guiding duct 12 between the evaporator 16 and the heating body 18 runs largely rectilinearly and without deflection. A bypass duct 20, which is variably closable by means of an adjustable cold air flap 22, is situated parallel to the heating body 18 and below the latter. A V-shaped stratification duct 24 is arranged downstream of the bypass duct 20, said stratification duct 24 being explained in more detail in the following. Several relatively small closure flaps 26 are arranged upstream of the heating body 18, said closure flaps 26 being capable of variably blocking the heating body 18 if the latter is not to have flow pass through it. The closure flaps 26 are dimensioned and arranged such that they have only a small extent in the flow direction. If appropriate, a PTC supplementary heater 28, which can boost the heating power if required, can be arranged downstream of the heating body 18.

A plurality of outflow openings 30, 32, which are variably closable by means of pivotable flaps 34, 36, are provided downstream of the heating body 18 and downstream of the stratification duct 24.

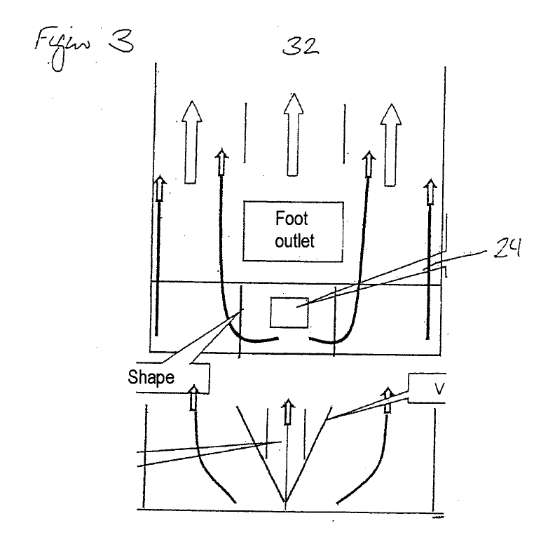

FIG. 2 shows a first operating mode of the air conditioning system 10, in which the flaps 26 upstream of the heating body 18 are closed and in which the cold air flap 22 in the bypass duct 20 is open. A footwell flap 34 is likewise closed here, so that all of the cold air flows upward in the direction of a defrosting nozzle 32 or a ventilation opening in the vehicle interior space. FIG. 3, in a section III-III corresponding to FIG. 2, shows the cold air distribution to the upper outflow openings 32 in the vehicle interior space. The V-shaped stratification duct 24 splits up the cold air and deflects it to a left-hand ventilation opening and a right-hand ventilation opening and, if appropriate, to defrosting nozzles.

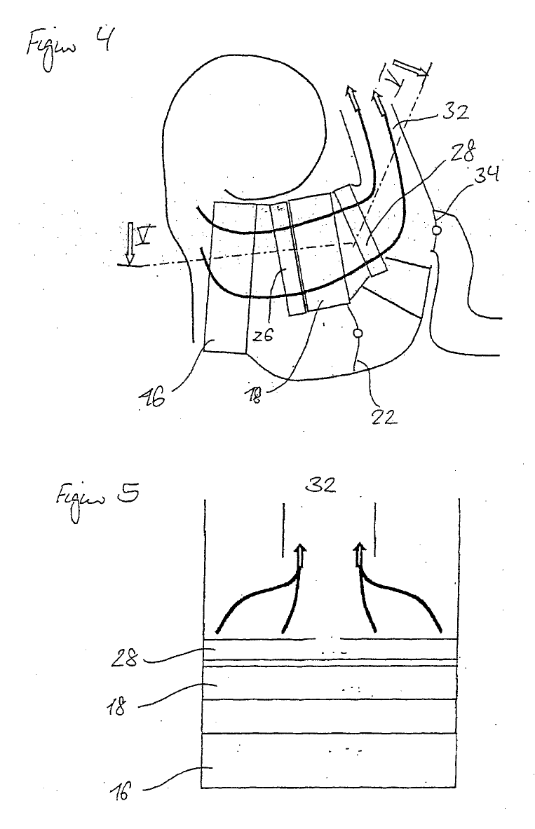

FIG. 4 shows an alternative operating mode of the air conditioning device 10 in which the cold air flap 22 is closed and the warm air flaps 26 are open. The footwell flap 34 is closed here, so that warm air is conducted to the upper outflow openings 32. FIG. 5 displays a section V-V from FIG. 4, whereby the air is conducted to the central outflow openings for the warm air after it has flowed through the evaporator 16, the heating body 18 and the PTC element 28.

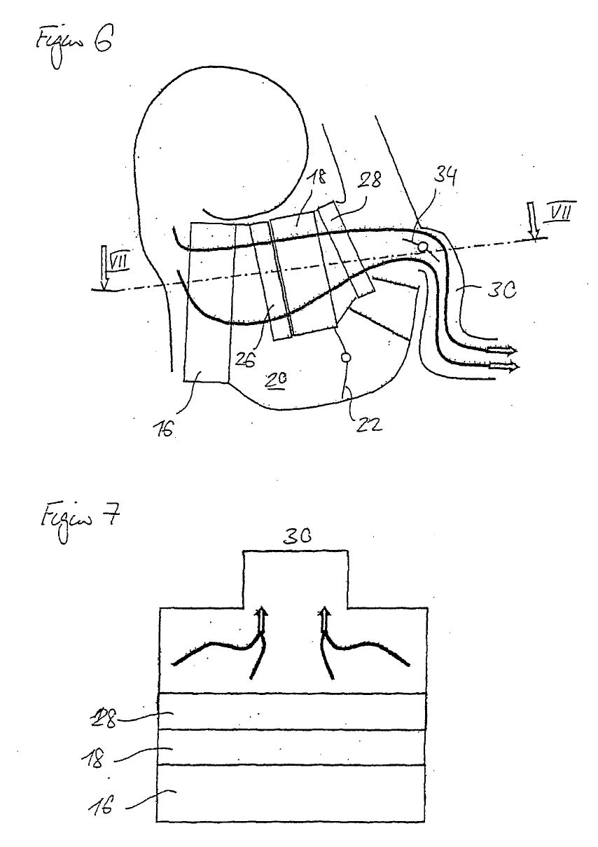

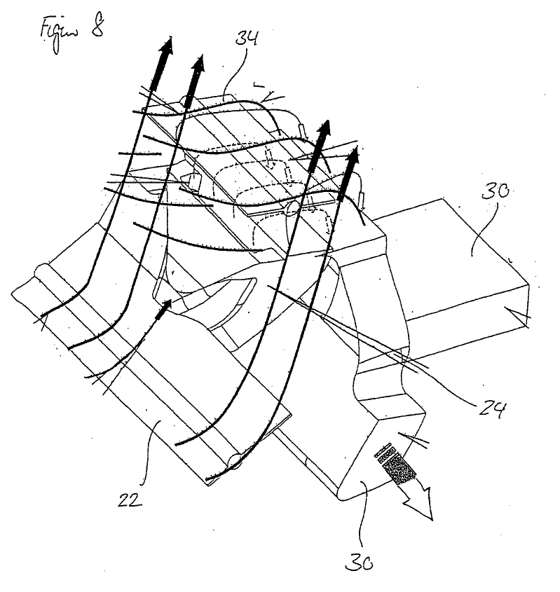

FIG. 6 shows an operating mode in which only warm air is supplied to the outlet openings 30 in the footwell. The cold air flap 22 is closed, while the warm air flaps 26 are open. The footwell flap 34 is likewise open. FIG. 7 displays a section VII-VII from FIG. 6, whereby the air is conducted via the open footwell flap 34 to the lower outflow openings 30 after it has flowed through the evaporator 16, the heating body 18 and the PTC element 28.

The schematic diagrammatic illustration of FIG. 8 displays the air paths of the air conditioning device 10 and, in particular, the mixture by means of the stratification duct 24. The cold air flap 22 in the bypass duct 20 is partially open here, so that cold air can flow through the bypass duct 20 and enter into the stratification duct 24. A proportion of the cold air is conducted upward and passes out of the upper outflow openings 32 (cf. FIG. 1), while a further proportion of the cold air is mixed in the stratification duct 24 with warm air from the heating body 18 and is conducted as temperate air to the lower outflow openings 30 in the footwell via the open footwell flap 34. Here, the laterally arranged openings 30 can be arranged in a front footwell, while the centrally arranged, relatively wide openings open out in a rear footwell of the vehicle interior space.

Finally, FIG. 9 displays an operating mode in which only cold air is fed upward in the direction for ventilating the vehicle interior space. The lower cold air flap 22 is opened, so that the cold air flows through the two lateral ducts and the V-shaped stratification duct 24. From here, the air again passes upward and flows through the open upper air duct which opens out into the upper outflow openings 32. Here, the footwell flap 34 is closed and is situated in an almost vertical position, so that all of the cold air can flow upward out of the mixing duct 24 along said flap 34.

1. An air conditioning device for climate control of a space, in particular of a vehicle interior space, having a heat exchanger which is arranged within an air guiding duct and can have air which is to be air conditioned pass through it, a heating device, through which flow can pass, being arranged downstream of said heat exchanger, wherein the air guiding duct runs largely rectilinearly and without deflection between the heat exchanger and the heating device.

2. The air conditioning device as claimed in claim 1, wherein a variably closable bypass duct for feeding cold air is provided in the air guiding duct parallel to the heating device.

3. The air conditioning device as claimed in claim 1, wherein the air guiding duct runs largely rectilinearly and without deflection between the heat exchanger and the bypass duct.

4. The air conditioning device as claimed in claim 1, wherein a closure device, which can be variably adjusted between a closed position and an opened position, is arranged within the bypass duct.

5. The air conditioning device as claimed in claim 1, wherein a further closure device, which can be variably adjusted between a closed position and an opened position, for metering warm air is arranged upstream or downstream of the heating device.

6. The air conditioning device as claimed in claim 5, wherein the further closure device in the warm air duct is formed from a plurality of pivoting flaps which are coupled together.

7. The air conditioning device as claimed in claim 5, wherein the further closure device in the warm air duct is formed from one or more flaps which can be moved and/or partially rolled up.

8. The air conditioning device as claimed in claim 1, wherein a stratification duct is arranged in the region downstream of the bypass duct, said stratification duct branching off a variably adjustable proportion of a cold air flow from the bypass duct and, in a first position of a flap which is arranged downstream, admixing it to a warm air flow from the heating device.

9. The air conditioning device as claimed in claim 8, wherein the stratification duct branches off a variably adjustable proportion of the cold air flow from the bypass duct and, in a second position of a flap which is arranged downstream, admixes it to the cold air flow from the bypass duct again.

10. The air conditioning device as claimed in claim 8, wherein the stratification duct has a V-shaped cross section.
